(19) United States
(12) Patent Application Publication
(10) Pub. No.: US 2007/0202361 A1
(43) Pub. Date: Aug. 30, 2007

(54) Interference generating, colored coating for surgical implants and instruments

(76) Inventors: Vinzenz Max Frauchiger, Solothurn (CH); Marcel Estermann, Diessbach (CH)

Correspondence Address: JONES DAY, 222 EAST 41ST STREET, NEW YORK, NY, 10017-6702, US

(21) Appl. No.: 11/650,269

(22) Filed: Jan. 5, 2007

Related U.S. Application Data
(63) Continuation of application No. PCT/CH04/00422, filed on Jul. 6, 2004.

(51) Int. Cl. B32B 15/04; B32B 9/00

(52) U.S. Cl. 428/701; 623/926; 428/702; 428/698; 428/696; 428/472

(57) ABSTRACT

The coating is particularly suited for identifying and characterizing surgical implants and instruments as well as for providing a diffusion barrier for surgical implants and instruments. The coating comprises a biocompatible, transparent and, in itself, colorless interference layer, which is joined to the surface of the implant or of the instrument, has a constant layer thickness, and which is not, or only slightly, electrically conductive, i.e., is dielectric. The coating is also suited for generating interferences and interference colors over the entire visible spectrum.

### CROSS-REFERENCE-RELATED APPLICATION

This is a continuation of pending International Application No. PCT/CH2004/000422, filed Jul. 6, 2004, the entire contents of which are expressly incorporated herein by reference thereto.

### FIELD OF THE INVENTION

The invention refers to a coating, in particular for a designation and characterization of surgical implants and instruments, as well as for a diffusion inhibitor coating of surgical implants and instruments.

### BACKGROUND OF THE INVENTION

Such coatings are especially used as color codes (for a designation and characterization) to allow differentiating various types and sizes of surgical implants or instruments, for instance bone plates, bone screws or screw drivers in a simple and safe manner, and thereby coordinating the compatibility of individual elements with each other. In bone screws this allows differentiating the diameter, the driving system (for instance the torque, hexagon, right hand thread, or left hand thread) and other features. Walker et al. U.S. Pat. No. 5,597,384 disclosed a suitable coding scheme, but without indicating how the coating is applied to the implant's surface. It is however known, for instance from WO00/74637, that a thin coating of a diamond-like carbon DLC is applied to the implant for this purpose, in particular by using a pulsating arc of carbon plasma. A disadvantage of these known color-coded coatings is that many of them are electrically conductive and therefore subject to corrosion by occasional potential differences. Moreover, these know color-coded coatings are partially porous, poorly adhering to the substrate and of a material-dependent color, which affords only a limited coloring range.

### SUMMARY OF THE INVENTION

The object of the invention is to apply a coating on surgical implants or instruments that is not susceptible to corrosion, displays good biocompatibility, allows a freely applicable color characterization over the entire color spectrum and acts as a diffusion inhibitor for allergenic substances such as nickel or molybdenum (substrate materials).

The coating of the invention is biocompatible, transparent and—considered in itself—a colorless interference coating bonded to the surface of the implant or the instrument, which presents a constant coating thickness; has no or only weak electrical conductivity, thus being dielectric; is suitable for generating interferences; and is suitable for generating interference color over the entire visible spectrum.

The advantages of the invention are many and include the following:
a) The colors may be generated from the entire visible spectrum, thus for instance red, orange, yellow, green, blue, indigo, and violet;
b) The coating is not susceptible to corrosion currents capable of damaging, peeling off or dissolving the coating;
c) The coating is resistant and protects against chemical and heat attack;
d) The diffusion process is locally inhibited and the emission of metallic ions from the substrate is strongly reduced; and
e) The choice of suitable coating thicknesses and coating materials (meaning their refraction values) allows generating the desired interference colors.

The coatings according to the invention (or the individual coatings composing them) are colorless, and in themselves transparent, meaning that they exhibit no or only a weak absorption. The coloring is therefore not originated by the color pigments inherent in the coating material or in the coloring dies, as happens with conventional industrial colors. The technically simplest solution is the individual coating. This can for instance comprise TiO₂ or its sub-oxides, Ti₂O₃, Ti₃O₅ etc., as well as for instance Ta₂O₅, Nb₂O₅, ZrO₂, HfO₂ or mixtures of these, therefore metal oxides. Nitrogen compounds, for instance Si₃N₄, are also possible.

The materials to be used for the expected purpose are advantageously of an already proven biocompatibility. Because of the largely heat-insensitive nature of the substrate (implants, tools, screws, etc.) during the coating process these are optimally heated up to 330° C., thus considerably improving the adhesion and morphology of the coatings (lower porosity, increased hardness).

Experimental tests have shown that single coatings are already capable of generating an adequately intensive color impression, which is not diminished by both the adhesion coating and the top coating at suitably chosen thicknesses. Increasing the number of coatings, for instance by alternatively applied high and low refractive coatings, nevertheless allows deepening the color intensity further (see FIG. 3). Beside requiring extended coating periods, such multicoating systems nevertheless tend, because of the greater number of separating surfaces—meaning points of attack—to increase their vulnerability to external influences (sterilization, disinfection).

The greatest challenge for the coatings are the aggressive cleaning treatments in practical usage, for instance sterilizing at 135° C., washing in strongly alkaline solutions at pH values around 10-12, and this in several hundred successive cycles. The destroying mechanisms acting on the coatings in these situations are diffusion processes (humidity or solutions penetrating the border or separating surfaces of the coated systems, as well as directly acting external influences on the coating surface, especially on pores, fractures, surface damages etc. The latter may be alleviated by applying so-called top-coatings or protective coatings. The protective coatings may consist of any of the dielectric materials mentioned above, including the materials of a low refractive index (for instance MgF₂, n=1.38; SiO₂, n=1.46; Al₂O₃, n=1.63.

The polished surfaces of medical implants and surgical instruments reflect the visible light (wavelengths of λ=400 nm (violet) up to 700 nm (red)), depending on surface quality (polishing, roughness, depth) between 40% and 60%. Because the reflective ability (reflection values) is approximately the same over the entire visible spectrum, the resulting impression on the human eye is of a white, metallic, silvery sheen (see FIG. 1). This effect is particularly apparent in precision-made optical aluminium or silver mirrors, whose reflection values are above 90% (FIG. 2). However, where the curving profiles are not uniformly flat, but for instance rising—due to the different spectral reflecting behaviour of the corresponding materials—this leads to a characteristically colored sensual impression of the individual materials. FIG. 2 shows this on the example of copper and gold, whose well known colors (yellow-orange or gold-colored) are induced by the low reflection coefficient (greater absorption) in a low wave range (400 nm to about 550 nm).

The principle of color generation by dielectric coatings on implant surfaces thus rests on the possibility of modifying the course of their uniformly constant reflection curves (FIG. 1) in an aimed manner, so as to obtain the needed color effects.

This color hue derives from the interference (superposition) of separate wave lengths. The process is outlined in detail in the literature by Angus Macleod, “Thin Film Optical Filters”, 3.d Edition, Institute of Physics Publishing, Bristol and Philadelphia, or by H. K. Pulker “Coatings on Glass”, 2nd revised Edition, Elsevier-Verlag. A portion of the incident light is reflected at the air-to-coating interface, while the residual portion crosses the coating. On the coating-to-metal separating surface even this residual is reflected and interferes while exiting the coating with the original reflected beam (FIG. 3). Depending on the phase difference of the light waves (induced by the coating thickness and the refraction value), standard curve profiles inducing the desired color impression may be produced.

At the same coating material, TiO2 with n=2.3, and at appropriately coordinated coating thicknesses, FIGS. 4 to 7 show the characteristic spectral reflection curves of blue (d≈65 nm), yellow (d≈130 nm), red (d≈150 nm) and green (d≈200 nm).

The interference coating advantageously consists of a homogeneous material, meaning a material of a constant chemical composition, morphology, and refraction index.

In another embodiment, the interference coating may also be inhomogeneous and consist in particular of a material whose refraction value varies continuously in a direction perpendicular to the interference coating (such as in a “rugate filter”).

It is moreover advantageous if the interference coating is corrosion resistant and preferably will not adversely affect the corrosion resistance of the implants or instruments.

The interference coating may comprise the following substances or mixtures thereof:
a) Oxides or suboxides of the elements Si, Ta, Ti, Y, Zr, Al, Cr, Nb, V and Hf;
b) Nitrides of the element silicon; or
c) Fluorides of the element magnesium.

The oxide or suboxide may be chosen from the group: titanium oxide (TiO₂ and Ti₂O₃), tantalum oxide (Ta₂O₅), zirconium oxide (ZrO₂), hafnium oxide (HfO₂), niobium oxide (Nb₂O₅), yttrium oxide (Y₂O₃), aluminium oxide (Al₂O₃) and silicon oxide (SiO₂) or their suboxides. The nitride can be silicon nitride (Si₃N₅) and the fluoride can be magnesium fluoride (MgF₂).

The interference coating typically presents a refraction value of n>1.9, preferably n>2.2. The advantage of these higher refraction values lies in their stronger action when modifying the flat course of the curve of the naked substrate surface.

In order to satisfy the manifold requisites of a color coding, its specific characteristics may be influenced in an aimed fashion by amplifying the number of coatings. In a particular form of embodiment, the interference coating therefore consists of multiple, superposed individual coatings forming a coated interference system. Because the coating according to the invention is in itself transparent, the reflection on various coating transitions (interfaces) leads to an overlapping of waves that reinforce each other in certain spectral regions and cancel each other in others, which leads to the desired reflection behaviour within the spectrum (see the curve diagrams according to FIGS. 4-7).

The interference coating system, or its individual coatings—each considered in itself—typically display a thickness of at least 500 nm, preferably of a maximum 250 nm, while a minimal thickness of at least 10 nm is advantageous.

The uncoated surface of the transplant or instrument is advantageously composed of steel, a Co-based alloy, titanium, NiTi or a titanium alloy. In a preferred form of embodiment, the interference coating consists of non-conductive titanium oxide (TiO₂).

In a further form of embodiment, an intermediate adhesive coating is arranged between the interference coating and the surface of the implant or instruments. The adhesive coating may include an oxide or suboxide of the elements Si, Ta, Ti, Y, Zr, Al, Cr, Nb, V and Hf, in particular of a chromium oxide or a silicon oxide or mixtures thereof. The oxide or suboxide may be chosen from the group: titanium oxide (TiO₂), tantalum oxide (Ta₂O₅), zirconium oxide (ZrO₂), niobium oxide (Nb₂O₅), or silicon oxide (SiO₂) or their suboxides. The adhesive coating advantageously presents a thickness of at least 2 nm, preferably at least 10 nm. The maximum thickness of the adhesive coating is advantageously a maximum of 20 nm, preferably a maximum of 10 nm.

In a particular form of embodiment, a top coating is applied to the interference coating. The top coating serves a protective function and leads to an improved abrasive resistance and hardness of the coating. The top coating may include one of the following substances or mixtures thereof:
a) Oxides or suboxides of the element Si, Ta, Ti, Y, Zr, Al, Cr, Nb, V and Hf;
b) Nitrides of the element silicon; or
c) Fluorides of the element magnesium

The top coating preferably includes Al₂O₃, MgF₂ or mixtures thereof.

The oxide or suboxide may be chosen from the group: titanium oxide (TiO₂), tantalum oxide (Ta₂O₅), zirconium oxide (ZrO₂), niobium oxide (Nb₂O₅), silicon oxide (SiO₂) or their suboxides.

The top coating is preferably of an equal or lower thickness than the interference coating.

In another form of embodiment, the refraction values n of the individual adjacent coatings of the interference coating present a difference Δn of at least 0.5, preferably of at least 0.7. This results in a larger effect in generating the color, meaning stronger colors and better contrasts.

In a further embodiment, individual interfaces, preferably made of aluminium oxide Al₂O₃, are arranged between
a) the surface of the implant or of the instruments;
b) the interference coatings;
c) the adhesive coatings; and/or
d) the top coating.

These interfaces act as a diffusion inhibitor coating or to improve the mechanical characteristics. This results in better adhesive strength, coating hardness, abrasive resistance, compensation of mechanical stresses inside the coatings, as well as in a better electrical insulation. The diffusion inhibitor coating also prevents emitting potentially harmful substrate materials toward the human body.

The diffusion inhibitor coating advantageously presents a thickness of at least 10 nm, preferably at least 25 nm. The maximum thickness of the diffusion inhibitor coating is at least 10 nm, preferably at least 25 nm. The maximum thickness of the diffusion inhibitor coating is advantageously at least 1000 nm, preferably at least 50 nm.

The interference coating is preferably devoid of pores.

The production of the coating according to the invention may be done by coating the surface of an implant or instrument by a PVD process (Physical Vapour Deposition), a CVD process (Chemical Vapour Deposition), a sputter process—in particular also by using an ion source or an ion gun—or a SolGel process with atoms from the group Mg, Si, Ta, Ti, Y, Zr, Al, Cr, Nb, V and Hf. The ion gun may for instance be a Kauman gun. Prior to the coating with atoms, the surface is advantageously subjected, for cleaning purposes, to an ion bombardment, preferably with Ar, O₂ or N₂ ions or combinations thereof. The interference coating applied to the surface may be after-oxidized with O₂, preferably in a circulating air tempering furnace.

The coating according to the invention may also be employed as a diffusion inhibitor coating.

### BRIEF DESCRIPTION OF THE DRAWINGS

The invention and further developments of the invention are explained in even greater detail by means of partially simplified representations of several examples, in which:

FIG. 1 shows a spectral reflection curve of a polished implant surface. The respective reflecting power depends on the surface quality in question, thus on its polishing;

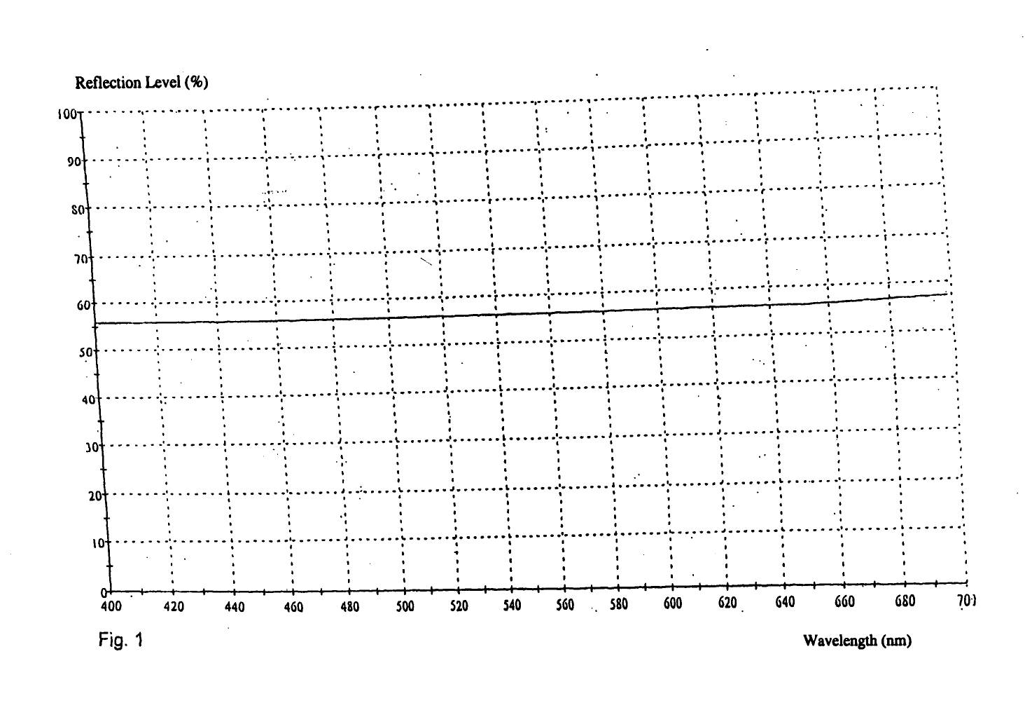

FIG. 2 shows spectral reflection curves of Au-, Cu-, and Al-mirror surfaces;

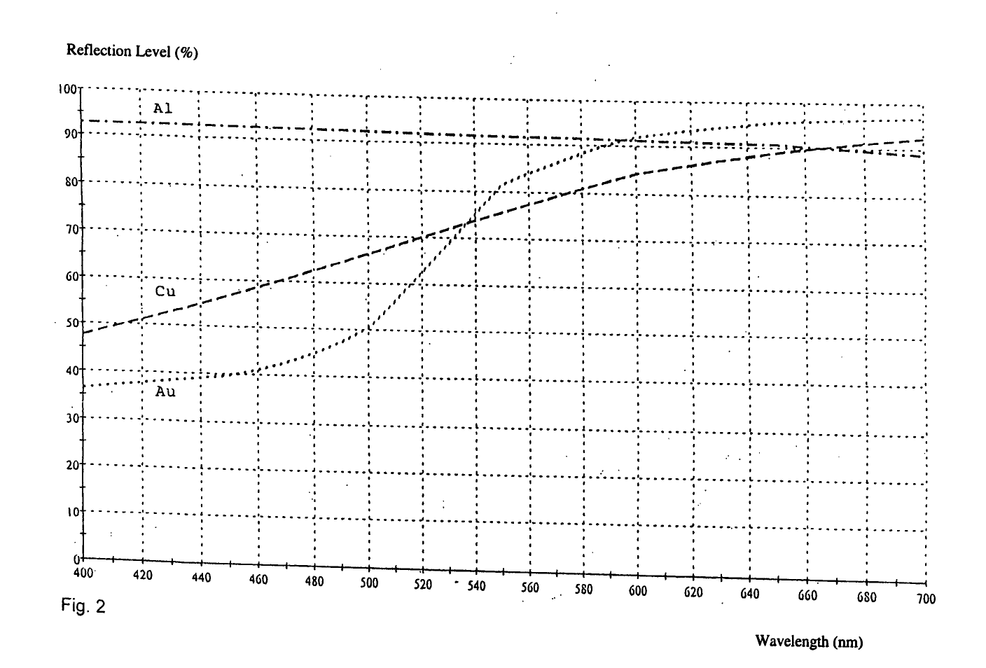

FIG. 3 shows two simplified representations of a coloring by interference;

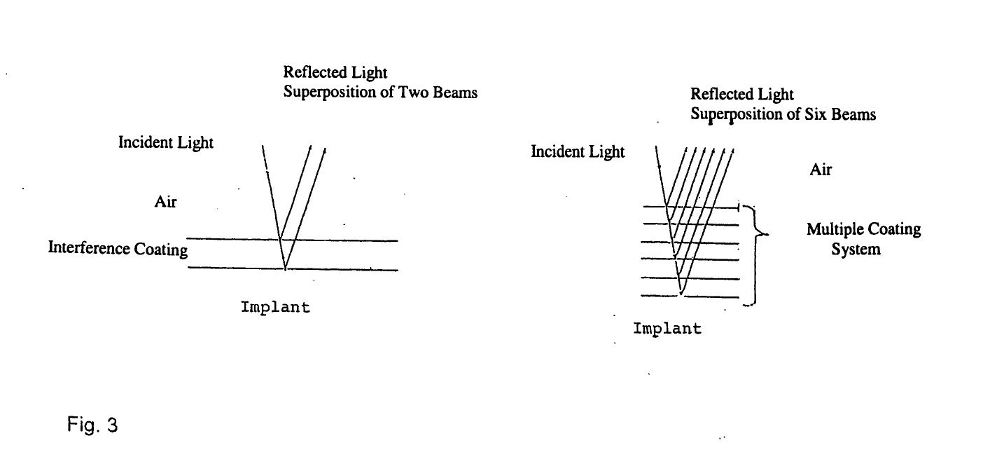

FIG. 4 shows the spectral reflection curve of an implant surface with a coating according to the invention made of titanium dioxide to generate the color blue (coating thickness about 65 nm);

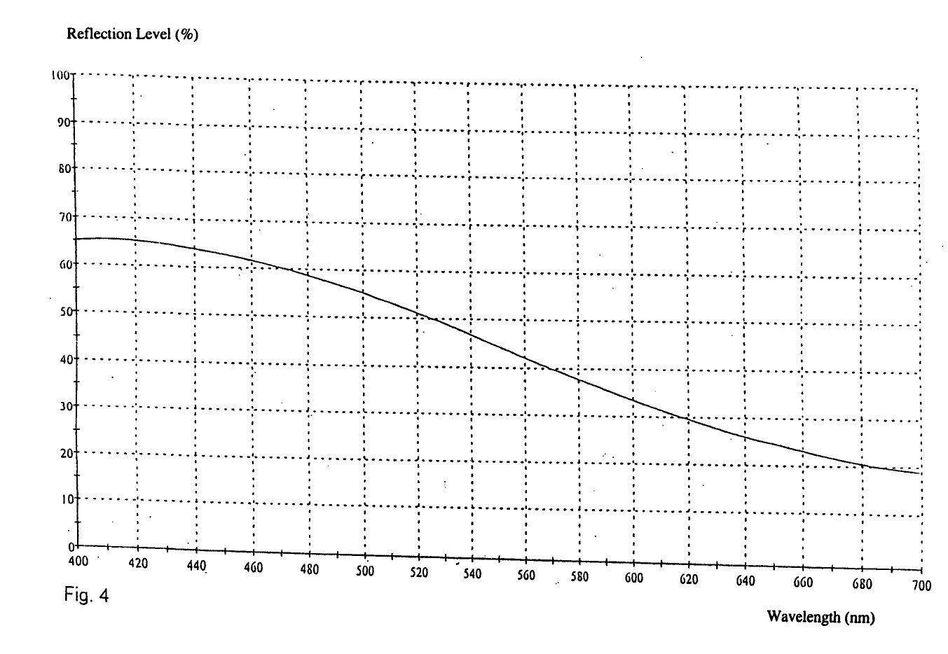

FIG. 5 shows the spectral reflection curve of an implant surface with a coating according to the invention made of titanium dioxide to generate the color gold (coating thickness about 130 nm);

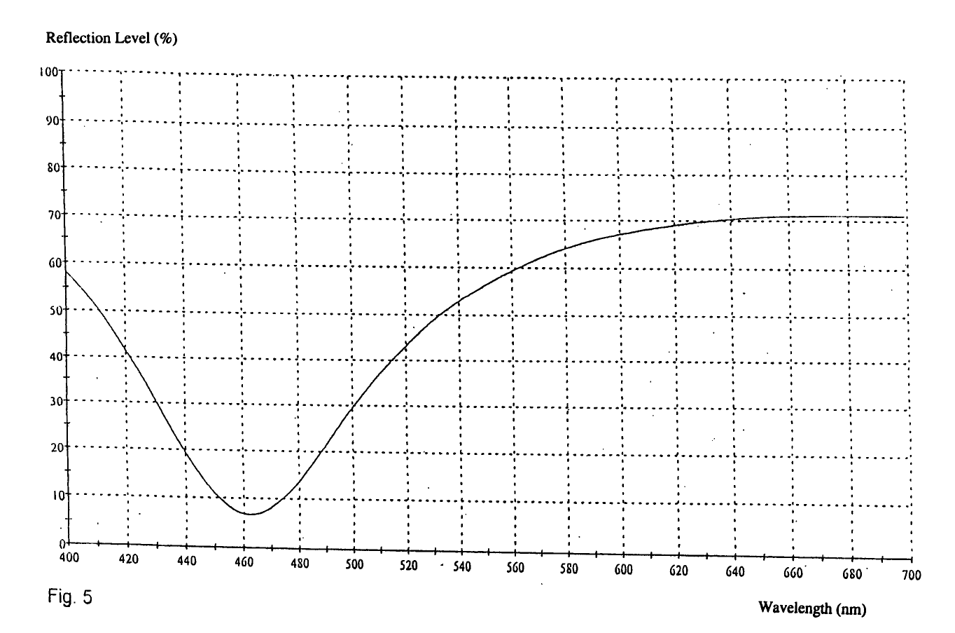

FIG. 6 shows the spectral reflection curve of an implant surface with a coating according to the invention made of titanium dioxide to generate the color red (coating thickness about 150 nm); and

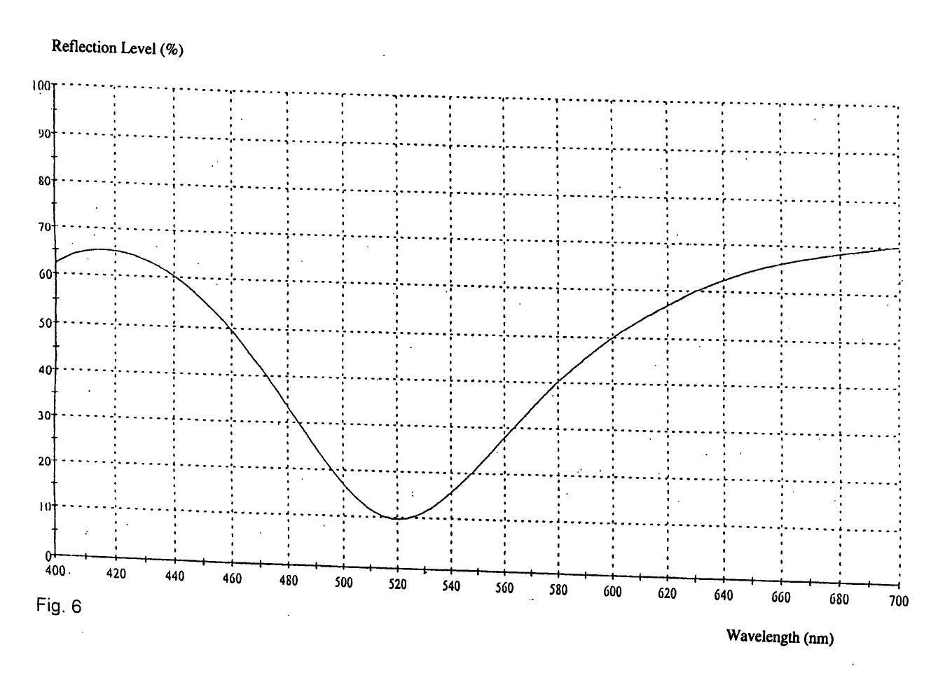

FIG. 7 shows the spectral reflection curve of an implant surface with a coating according to the invention made of titanium dioxide to generate the color green (coating thickness about 200 nm).

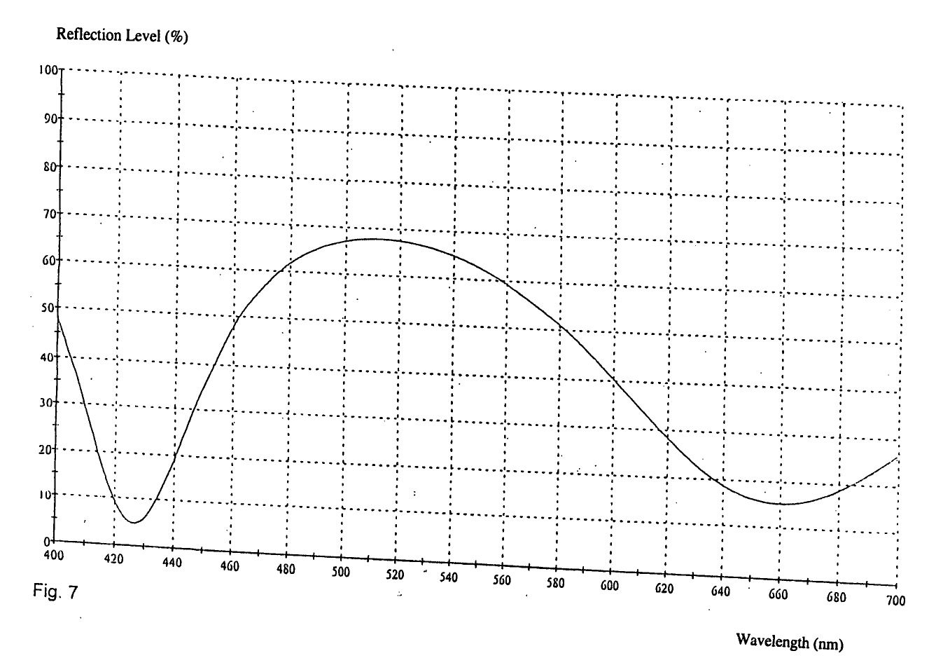

### DETAILED DESCRIPTION OF THE INVENTION

The application of the above color codings on medical implants and surgical instruments does not therefore correspond to the conventional coloring processes, such as painting or spraying on surfaces. It exploits the vacuum coating technologies described above.

All these methods are known standard optical and electronic processes, such as used in applying reflection reducing coatings on lenses (cameras, binoculars, microscopes and the like) or eyeglasses, in the coating of wafers for the production of chips, or for the application of hard coatings (for instance in the ion-plating process) on tools (drills, punching tools) in order to boost their useful lifetime.

The mentioned technologies are detailed in the branch literature, for instance by Angus Macleod and H. K. Pulker.

### Thermal Coating Operation (PVD)

a) Full (partial) ultrasonic substrate cleaning in a cleaning solution;
b) Substrate drying;
c) Inserting in support;
d) Introducing into the vacuum chamber;
e) Pumping off the vacuum chamber (evacuating to a 10⁻⁶ mbar range) and simultaneous heating of the substrate from 40° C. up to 500° C. (optimally to 300° C.);
f) Heating the coating material (pure Ti or its oxides TiO₂, TiO₃, etc.) above the fusion point;
g) Opening the cover plate of the vaporizing source at the condition “f”, so as to direct the stream of vaporized particles into the vacuum chamber, while adding oxygen (met atom oxidation);
h) Monitoring and maintaining the desired coating thickness generating the color effect, by using a thickness measuring instrument (vibrating quartz or optical monitor);
i) Closing the cover plate after achieving the coating thickness;
j) Applying eventual further coatings, or a prior adhesive coating;
k) Allowing the fused mass in the vaporizing source to cool down;
l) Flooding the vacuum chamber;
m) Extracting the samples and allowing them to cool off completely.

Ion sources may act to support this process by cleaning the surface prior to coating while removing the topmost atom layers of the substrates, as well as later by compacting the coating while being added to the coating. An after-oxidation of the interference coating with O₂, for instance in a circulating air tempering furnace, may eventually follow.

### Sputter Process Operation

a) Ultrasonic cleaning of the samples in a cleaning solution;
b) Drying the samples;
c) Inserting into the sample holder;
d) Introducing into the vacuum chamber;
e) Pumping off the vacuum chamber to a 10⁻⁶ mbar range;
f) Accelerating the ions (Ar-ions) to the target, from which the atomization (sputtering-off) of the coating material occurs;
g) For pure titanium, adding oxygen (oxidation of the pure metal atoms);
h) The coating thickness is determined by a prior calibration, or may also be checked in time;
i) After reaching the coating thickness, admitting air; and
j) Taking samples and allowing to cool.

### Example of a Thermal Coating of a Bone Screw with a Blue Titanium Oxide Coating

1. An electrically polished bone screw was subjected to a multiple-stage ultrasonic washing process in an alkaline solution, with a final cleaning step in deionized water for 10 minutes.
2. The bone screw was subsequently dried for 5 minutes in a hot air oven.
3. The bone screw was inserted with pincers in a holding bracket and the latter was introduced into the vacuum chamber and anchored to the holder provided for this purpose.
4. After closing all the openings of the vacuum chamber, the same was evacuated to about 5×10-6 mbar and the bone screw was heated by substrate heating to 300° C.
5. The crucible of the vaporizing source was brought up to the vaporizing temperature of the vaporizing material (about 2,000° C.).
6. The cover plate above the titanium source was then removed, and the vaporization of the titanium atoms, while adding oxygen for oxidation, occurred in the entire vacuum chamber.
7. The coating occurred over a period of 10 minutes, until a coating thickness of 65 nm could be measured by a suitable thickness measuring instrument (vibrating quartz or optical monitor), and the cover plate could again close the crucible of the vaporizing source.
8. The vacuum chamber was then flooded, and after reaching the ambient pressure, the chamber door was opened and the coated bone screw was extracted.
9. The coated bone screw was extracted from the apparatus and cooled off for 10 minutes on the ambient air and then removed from its clamp holder, thus ending the coating process.

The present invention has been described in connection with the preferred embodiments. These embodiments, however, are merely for example and the invention is not restricted thereto. It will be understood by those skilled in the art that other variations and modifications can easily be made within the scope of the invention as defined by the appended claims, thus it is only intended that the present invention be limited by the following claims.

We claim:

1. A coating for designating or identifying particular surgical implants and instruments and for providing a diffusion inhibitor coating thereon, the coating comprising:
first coating comprising a biocompatible, transparent, and in itself colorless layer that is dielectric, bondable to the surface of a surgical implant or instrument, suitable for generating interferences, and suitable for generating interference color over the entire visible spectrum.

2. The coating of claim 1 wherein the first coating comprises a homogeneous material.

3. The coating of claim 1 wherein the first coating comprises a material remaining constant in regard to its chemical composition, morphology, and refraction index.

4. The coating of claim 1 wherein the first coating comprises an inhomogeneous material.

5. The coating of claim 1 wherein the first coating comprises a material whose refraction value varies continuously in a direction running perpendicularly to the first coating.

6. The coating of claim 1 wherein the first coating is corrosion resistant and does not affect the corrosion resistance of the surface of the implant or instrument.

7. The coating of claim 1 wherein the first coating comprises one of the following substances or mixtures thereof:
oxides or suboxides of the elements Si, Ta, Ti, Y, Zr, Al, Cr, Nb, V and Hf;
nitrides of the element silicon; or
fluorides of the element magnesium

8. The coating of claim 7 wherein the oxide or suboxide is chosen from the group consisting of: titanium oxide (TiO₂ and Ti₂O₃), tantalum oxide (Ta₂O₅), zirconium oxide (ZrO₂), hafnium oxide (HfO₂), niobium oxide (Nb₂O₅), yttrium oxide (Y₂O₃), aluminium oxide (Al₂O₃) and silicon oxide (SiO₂) or their suboxides.

9. The coating of claim 7 wherein the nitride is silicon nitride (Si₃N₄) and the fluoride is magnesium fluoride (MgF₂).

10. The coating of claim 1 wherein the first coating has a refraction value of n>1.9.

11. The coating of claim 10 wherein the first coating has a refraction value of n>2.2.

12. The coating of claim 1 wherein the first coating comprises several superposed individual first coatings.

13. The coating of claim 12 wherein the superposed first coatings or the individual first coatings, each considered in itself, have a maximum thickness of 500 nm.

14. The coating of claim 12 wherein the superposed first coatings or the individual first coatings, each considered in itself, have a thickness of at least 10 nm.

15. The coating of claim 12 wherein the refraction values n of individual adjacent first coatings have a difference Δn of at least 0.5.

16. The coating of claim 1 further comprising the implant or instrument to be coated, wherein the uncoated surface of the implant or instrument comprises steel, a Co-based alloy, titanium, NiTi, or a titanium alloy.

17. The coating of claim 1 wherein the first coating further comprises non-conductive titanium oxide (TiO₂).

18. The coating of claim 1 wherein the first coating is bondable to the surface of the implant or instrument according to a PVD process (Physical Vapour Deposition), a CVD process (Chemical Vapour Deposition), a sputter process, or a SolGel process.

19. The coating of claim 1 wherein an intermediate adhesive coating is arranged between the first coating and the surface of the implant or instrument.

20. The coating of claim 19 wherein the adhesive coating comprises an oxide or suboxide of the elements Si, Ta, Ti, Y, Zr, Al, Cr, Nb, V and Hf or mixtures thereof.

21. The coating of claim 20 wherein the oxide or suboxide of the adhesive coating is selected from the group consisting of: titanium oxide (TiO₂), tantalum oxide (Ta₂O₅), zirconium oxide (ZrO₂), niobium oxide (Nb₂O₅), or silicon oxide (SiO₂) or their suboxides.

22. The coating of claim 19 wherein the adhesive coating has a thickness of at least 2 nm.

23. The coating of claim 19 wherein the adhesive coating has a maximum thickness of 20 nm.

24. The coating of claim 1 further comprising a top coating applied on the first coating.

25. The coating of claim 24 wherein the top coating comprises one of the following substances or mixtures thereof:
oxides or suboxides of the elements Si, Ta, Ti, Y, Zr, Al, Cr, Nb, V and Hf;
nitrides of the element silicon; or
fluorides of the element magnesium.

26. The coating of claim 25 wherein the top coating comprises Al₂O₃, MgF₂, or mixtures thereof.

27. The coating of claim 25 wherein the oxide or suboxide of the top coating is selected from the group consisting of: titanium oxide (TiO₂), tantalum oxide (Ta₂O₅), zirconium oxide (ZrO₂), niobium oxide (Nb₂O₅), or silicon oxide (SiO₂) or their suboxides.

28. The coating of claim 24 wherein the top coating has a thickness equal to or less than the thickness of the first coating.

29. The coating of claim 1 further comprising an adhesive coating and a top coating, wherein individual interfaces made of Al₂O₃ are arranged between the surface of the implant or of the instruments; the first coatings; the adhesive coatings, and/or the top coating as a diffusion inhibitor coating or to improve the mechanical characteristics of the coatings.

30. The coating of claim 29 wherein the diffusion inhibitor coating has a thickness of at least 10 nm.

31. The coating of claim 29 wherein the diffusion inhibitor coating has a maximum thickness of 1,000 nm.

32. The coating of claim 1 wherein the first coating is devoid of pores.

33. A method of applying a coating to the surface of a surgical implant or instrument comprising:
applying a biocompatible, dielectric, transparent, and in itself colorless coating to the surgical implant or instrument by a PVD process (Physical Vapour Deposition), a CVD process (Chemical Vapour Deposition), a sputter process, or a SolGel process with atoms selected from the group consisting of Mg, Si, Ta Ti, Y, Zr, Al, Cr, Nb, V and Hf.

34. The method of claim 33 further comprising prior to applying the coating with the atoms, bombarding the surface with Ar-, O₂- or N₂-ions or combinations thereof to clean the surface.

35. The method of claim 33 further comprising after-oxidizing the surface with O₂ in a circulating air tempering furnace.

36. The method of claim 33 wherein a sputter process is used with an ion source or an ion gun.
